(19) United States
(12) Patent Application Publication
(10) Pub. No.: US 2021/0338014 A1
(43) Pub. Date: Nov. 4, 2021

(54) Utensil Holder

(71) Applicant: David Russell, Layton, UT (US)

(72) Inventor: David Russell, Layton, UT (US)

(21) Appl. No.: 16/863,920

(22) Filed: Apr. 30, 2020

(51) Int. Cl. A47J 47/16

(52) U.S. Cl. CPC A47J 47/16

(57) ABSTRACT

A novel implement holder is provided. In particular, the present invention provides a utensil holder that allows for a neat and clean work area without unsightly spills from liquids. The invention is particularly suited to kitchens and coffee shops, where there is a need to collect drippings from spoons and other stirring utensils without inadvertently contaminating the stirring utensil and the subject liquids from contact contamination. The invention also provides for absorbent sheets that can be individually dispensed below a suspended utensil.

### FIELD OF THE INVENTION

This invention relates to a holder for utensils. In particular, the invention provides a novel device that allows a user to easily suspend dripping utensils over a collector and thereby maintain a clean and sanitary work environment. The present invention is particularly suited to kitchen utensils that are used to stir liquids. By using the present device, the person can engage in a single action or intermittent actions of stirring of a liquid without making an unsightly mess. The present invention also provides for a more sanitary environment by suspending the stirring utensil above a placement surface, thereby avoiding contact contamination. Although the invention is particularly suited to cooking environments, the present disclosure is not limited thereto. The present invention is also applicable to artistic painting, construction painting, automotive repair, and any other situation where the user desires to suspend a dripping implement without making a mess.

### BACKGROUND OF THE INVENTION

A common problem in kitchens is where to place a dripping utensil. When stirring a soup or other liquid concoction, the chef will often use a spoon, ladle, or spatula for intermittent stirring. It is quite common to place the utensil on a nearby cooking surface between stirrings. This is problematic, however, because the utensil could be subjected to contact contamination and thereby contaminate the batch of food. Further, this also tends to make the kitchen area's preparation surfaces messy. All too often, someone will place a plate, pan, or other item directly on top of the area where the utensil had previously dripped. It is cumbersome and undesired for the chef or others in the kitchen to have to constantly wipe counters and watch for spills and drips from a previously used utensil.

This same problem is also manifest in the simple act of stirring tea, coffee, or cocoa drinks. Individual tea, coffee, or cocoa drinkers often need a place to put a used stirring spoon that will not make a mess. It is common to place a small plate or bowl near the item being stirred as a place to lay the stirring utensil. This, however, introduces another dish for washing and sometimes leads to unwanted dinnerware breakage from accidents.

Over the years, there have been many different ideas to resolve the issue of where to place a needed utensil when not in use. U.S. Pat. No. 4,515,332 to Scharfy discloses a culinary utensil support that comprises two parallel bars affixed to a support block. According to Scharfy's disclosure, the block is placed near a surface edge so that the dripping utensil could be suspended over the edge. There are several problems with this arrangement, the most obvious being that the drips from the used utensil are merely relocated to a different area instead of being contained and collected. Further, the utensil could easily be dislodged from the gravity-driven arrangement of suspension between two opposing bars.

In U.S. Pat. No. 5,518,211 to Gaskill et al., a utensil holder for containers is disclosed. According to this disclosure, there is a clip that can be attached to an upper edge of a pan. The clip attaches to the pan on one side and to the utensil on the other side. This is convenient for keeping drips within the originating vessel. However, under continuous heat the clip and utensil are both prone to heating. This makes it difficult to grab the hot utensil without either burning your fingers or being forced to use an oven mitt or other type of hand protector. This is the same problem that exists with any type of container-connected gripping device, such as the implements shown in U.S. Pat. No. 5,678,790 to Dwyer, U.S. Pat. No. 5,730,405 to Nicholas, and U.S. Pat. No. 5,823,483 to Gaskill.

There exists a need in the art for a device that presents a simple and convenient way to hold a stirring utensil without causing unnecessary messes and without exposing the utensil to contamination. There further exists a need in the art for a device that provides a collector for collecting drippings from a stirring utensil, the collector being easy to clean. Still further, there exists a need in the art for a utensil holder that is sturdy, not prone to breakage, and secure in its placement on a countertop near a cooking area.

### BRIEF DESCRIPTION OF THE DRAWINGS

FIG. 1 illustrates a perspective view of one embodiment of the utensil holder of the present invention.

FIG. 2 illustrates a perspective view of one embodiment of a roll-type collector of the utensil holder of the present invention.

FIG. 3 illustrates a perspective view of one embodiment of a spring-loaded collector of the utensil holder of the present invention.

FIG. 4 illustrates a perspective view of the collector shown in FIG. 3. loaded with absorbent sheets.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity.

### DETAILED DESCRIPTION OF THE INVENTION

Reference will now be made in detail to the presently preferred embodiments of the invention. There are also representative examples of the invention illustrated in the accompanying drawings. Throughout the following detailed description, the same reference numeral refers to the same elements in all figures.

The present invention provides a utensil holder that cleanly collects drippings from a used utensil or other type of tool or device used with liquids. The invention is particularly suited for use in a kitchen with soups, broths, stews, drinks, liquid gelatin preparations, creamy deserts, and the like. In one embodiment, the invention provides for more long-term and permanent placement by providing a collector that accommodates disposable absorbents. The embodiment with disposable absorbents is also easier to clean and does not require constant washing as would normally be required with a plate or saucer.

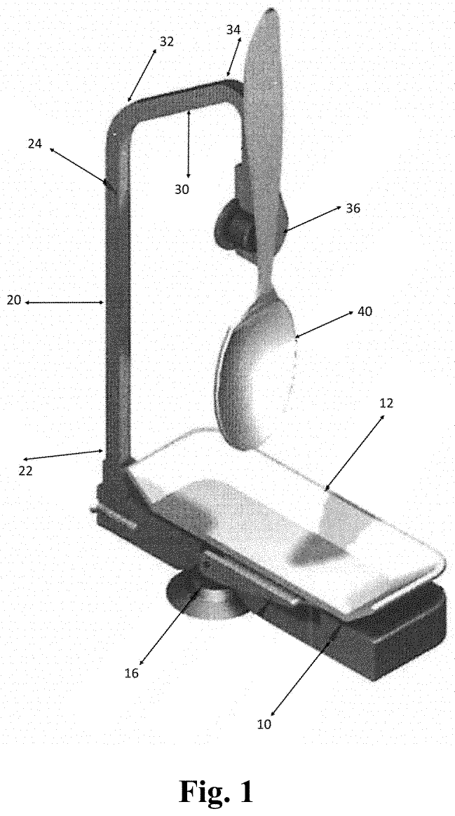

FIG. 1 shows one embodiment of a utensil holder of the present invention. There is a base 10 that provides a supporting dais for the present invention. Base 10 can be formed with a recessed surface for accepting a matching protruding surface of collector 12 for secure yet removable integration between the two. In one embodiment, collector 12 is a concave vessel of generally rectangular shape. The present invention also contemplates collectors of various shapes, including circular shapes, and even fingered shapes to accommodate a multitude of separately suspended utensils. One advantage to providing a concave vessel is that larger amounts of drippings can be caught by collector 12 and the user can go for a longer period of time without needing to empty the vessel of drippings from the utensils. Base 10 is provided with feet 14 that can be made of rubber or softer plastics that provide gripping action on smooth surfaces of either tile, metal, or composites. In one embodiment of the invention, suction cup 16 is affixed to a lower portion of base 10 and provides more secure and permanent mounting options to the underlying surface than would feet 14. It is also possible to provide a combination of both feet 14 and suctions cups 16 such that the user would be able to selectively, either temporarily or semi-permanently, affix the utensil holder, depending on need.

An extender 20 rises up from base 10 and provides continuity for an elevated platform or other type of area for locating a suspended utensil. A lower portion 22 of extender 20 is affixed to base 10, while an upper portion 22 of extender 20 is affixed to projector 30, which provides a laterally directed arm or protrusion. Proximal end 32 of projector 30 is connected to extender 20, while distal end 34 of projector 30 is provided with a means for attaching a utensil, such as a spoon 40, to distal end 34 of projector 30. In one embodiment of the present invention, a magnet 36 is provided at distal end 34 for magnetically attracting and holding metal utensils. In another embodiment of the invention, a utensil can be attached to distal end 34 via gripper 38. It will be known to those of ordinary skill in the art that a variety of grippers can be used within the spirit of the present invention, including metal clips, plastic clips, spring-biased clamps, hooks, and the like. One advantage to using magnet 36 is that metal spoons, which are very common stirring implements, can be quickly and conveniently attached to distal end 34. An advantage to a non-magnetized gripper 38 is that wooden implements can be easily attached to the utensil holder of the present invention.

According to one embodiment of the present invention, distal end 34 of projector 30 is of sufficient length that a suspended utensil will be centered over the middle of collector 12. In this way, there is less likelihood that drippings will fall outside of the intended zone of collection. This also provides for more swing room such that longer utensils can sway after placement without dripping beyond the edges of collector 12. The present invention also contemplates that base 10, extender 20, and projector 30 could be made of discrete parts affixed together or from one single extruded or formed piece. In yet another embodiment of the present invention, projector 30 is formed with a downward extension such that extender 20 and projector 30 form a general U-shape. In this manner, projector 30 also serves as a convenient handle for easily carrying the utensil holder.

It is also contemplated by the present invention that collector 12 need not be separate from base 10 but could be formed integral with the base. One advantage to providing collector 12 as a separate vessel is that it is easy to remove the vessel from the utensil holder for cleaning. In yet another embodiment, extender 20 has a telescoping feature so that the user can selectively arrange for the hanging of utensils of both short and long lengths. If a short utensil is suspended too high above collector 12 it is possible for the drippings from the utensil to splash and cause a mess. By providing a telescoping feature, this problem is eliminated.

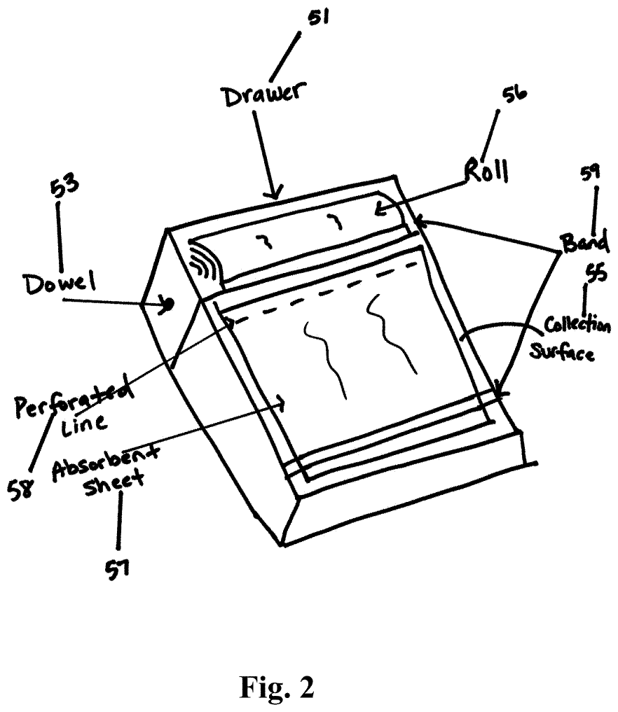

In another embodiment of the invention, collector 12 is configured in a drawer-like arrangement for holding and dispensing absorbent sheets. FIG. 2 shows one such arrangement. This figure shows collector 12 as having a drawer 51 that holds a roll 56 of absorbent sheets 57. There are matching dowel slots 52 (not shown) that accept support dowel 53, which is inserted into the middle of roll 56. It is also possible to provide end caps with rod-like protrusions that would stick into and support the rotational movement of roll 56 within drawer 51. The absorbent sheets 57 can be formed with perforations 58 that allow easy tearing of individual sheets from the roll. Bands 59 are affixed end-to-end across collection surface 55 and serve to hold down absorbent sheets 57 as they are pulled across collection surface 55. Under this configuration, the utensil holder of the present invention provides for easy dispensing of absorbent sheets that serve to soak up drippings from the suspended utensils.

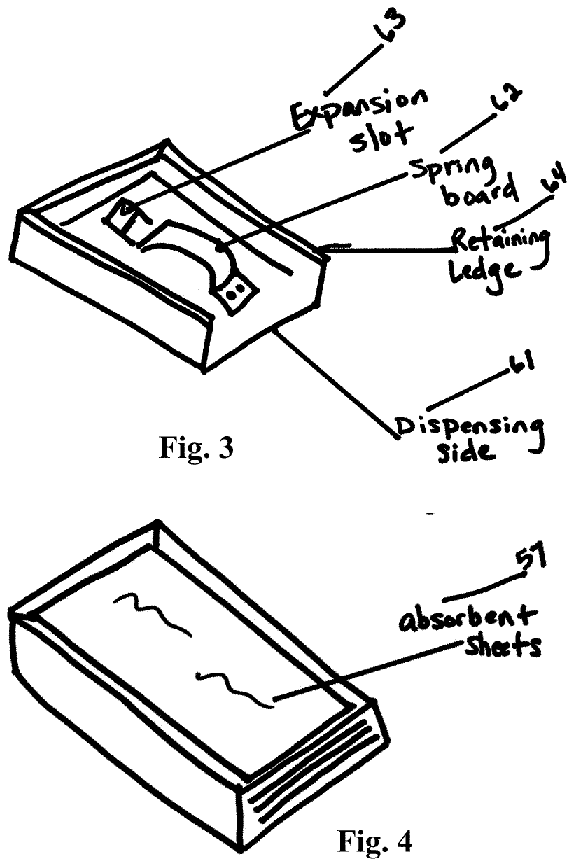

FIG. 3 shows another embodiment of collector 12. In this variant of the invention, collector 12 is formed as an open-ended container with a dispensing side 61. A spring band 62 is affixed on one end to a bottom inside surface of collector 12. At an opposite end, there is an expansion slot 63 that accommodates the spring-loaded length of spring band 62. The upper edges of collector 12 have retaining ledges 64 that prevent edged sheets 65 from rising above the top horizontal surface of collector 12. FIG. 4 shows the collector 12 fully loaded with absorbent edged sheets 65. In yet another embodiment, two spring bands 62 are provided on opposing sides of collector 12. In this version of the invention, the dual springs provide upward force only on the edges of edged sheets 65. This variant allows for less deformation of the center of the sheets, where the drippings will be collected and absorbed. It will be appreciated by those of ordinary skill in the art that the spring-loaded version of collector 12 shown in FIGS. 3 and 4 may require absorbent sheets that have thickened edges to better resist the force of spring bands 62.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An implement holder comprising a base, a vertical extender connected to said base, a projection arm extending in a horizontal direction from said vertical extender, and means for removably suspending an implement over said base.

2. The implement holder of claim 1, wherein said projection arm is sized to suspend said implement over a middle region of said base.

3. The implement holder of claim 1, wherein said vertical extender has a telescoping feature.

4. The implement holder of claim 1, wherein said base further comprises a removable collector dish.

5. The implement holder of claim 4, wherein said collector dish has a concave shape.

6. The implement holder of claim 1, wherein said base further comprises a receptacle for storing absorbent sheets.

7. The implement holder of claim 6, wherein said receptacle is configured to continuously direct absorbent sheets to a position under an implement suspended from said projection arm.

8. The implement holder of claim 6, wherein said receptable is configured to discretely dispense absorbent sheets under an implement suspended from said projection arm.

9. An implement holder comprising:
a base comprising a removable dish-shaped collector;
a telescoping vertical extender rising from said base;
a projector arm extending away from said vertical extender at a distal end from said base; and
means located on said projector arm for suspending an implement over said collector.

10. An implement holder comprising:
a base comprising a receptacle for storing absorbent material;
a telescoping vertical extender rising from said base;
a projector arm extending away from said vertical extender at a distal end from said base; and
means located on said projector arm for suspending an implement over said absorbent material.

11. The implement holder of claim 10, wherein said absorbent material comprises a roll of absorbent sheets.

12. The implement holder of claim 11, wherein said receptacle further comprises a drawer for holding said roll of absorbent sheets and means for directing clean, unused sheets under a suspended implement.

13. The implement holder of claim 10, wherein said absorbent material comprises individual absorbent sheets.

14. The implement holder of claim 13, wherein said receptacle is configured with a vertically biased spring to automatically feed new sheets to a location under a suspended implement.
